(19) United States
(12) Patent Application Publication
(10) Pub. No.: US 2018/0196858 A1
(43) Pub. Date: Jul. 12, 2018

(54) API DRIVEN ETL FOR COMPLEX DATA LAKES

(71) Applicant: The Bank of New York Mellon, New York, NY (US)

(72) Inventor: Kumar S. Srivastava, Mountain View, CA (US)

(21) Appl. No.: 15/867,418

(22) Filed: Jan. 10, 2018

Related U.S. Application Data
(60) Provisional application No. 62/445,166, filed on Jan. 11, 2017.

(51) Int. Cl. G06F 17/30; G06F 9/54

(52) U.S. Cl. CPC G06F 17/30563; G06F 9/547; G06F 17/30477; G06F 17/30427

(57) ABSTRACT

An extract, transform, load (ETL) orchestration interface receives an API script defining an ETL orchestration to extract data using a plurality of data projections and integrate the extracted data. Each data projection is defined as an API call and is associated with a particular data store. The ETL orchestration interface also receives a schedule for executing the ETL orchestration. The API script and the schedule are stored in an orchestrations store. An execution service executes the stored API script at a particular point of tie determined based on the schedule. Executing the stored API involves translating the API call for each data projection into a data query for extracting data from the data store associated with the data projection, executing the translated queries to extract the data, and integrating the extracted data according to the ETL orchestration.

### CROSS REFERENCE TO RELATED APPLICATIONS

This application claims the benefit of U.S. Provisional Application No. 62/445,166, filed Jan. 11, 2017. The content of the above referenced application is incorporated by reference in its entirety.

### TECHNICAL FIELD

This disclosure generally relates to an extract, transform, load (ETL) process that uses application programming interface (API) calls to access and integrate data from various sources.

### BACKGROUND

Complex data lakes are large systems of stored data. The data in a complex data lake includes data generated by different applications that produce data at different frequencies, with different formats, of different sizes and granularity, and stored on different hosts. Data lakes may offer a centralized data store where data from internal and external data sources can be stored and processed to produced insights and analytics. However, the process of combining and analyzing data from disparate data sets within a complex data lake typically involves Extract, Transform, Load (ETL) processes that are technically complex and difficult to manage.

In general, ETL processes involve extracting data from data sources, transforming the extracted data into a different format or structure, and loading the data into a target database or data warehouse. ETL processes can integrate data from multiple data sources, and may perform various functions on the data, such as aggregating, filtering, or summarizing the extracted data, based on the intended use of the final data product. Supporting ETL in complex data lakes requires data lake administrators to support a diverse set of ETL tools and to govern, monitor, and manage the ETL processes performed by users. Administration tasks involve, among other things, granting and revoking privileges, guaranteeing a high quality of service, performing quota management for offering a consistent level of service to all users of the system, and enabling an audit and compliance trail. Performing these tasks within complex data environment is challenging for the administrators. In addition, users retrieving data from a data lake and manipulating the data must be experienced with various database structures and formats and the diverse set of ETL tools, which limits the number of potential users who are able to access data from complex data lakes.

### SUMMARY

Embodiments described herein enable users to access data in a complex data lake using API calls. For example, if a complex data lake includes multiple data stores, each data store may accessible through one or more API calls. These API calls define data projections, which describe sets or subsets of data that can be retrieved from a particular data store for orchestration with additional data projections to form desired data sets. When executed, a data projection generates a particular data set based on the available data from the target data store at the time of execution. As one example, a data store may contain data describing a set of transactions, such as data describing the parties involved in each transaction, the value of each transaction, items in each transaction, the date of each transaction, etc. One example data projection for this data store may select all of the transaction parties. As transactions are added to the data store, the set of transactions changes, so the data set resulting from an executed data projection from a given date may include transacting parties that were not included in the resultant data set when that data projection was executed at an earlier date.

To perform an ETL process, a user can write an API script that includes API calls for data projections. The API script can include API calls to extract data from multiple sources. For example, an API script for an ETL process may specify that data is retrieved from two different data sources using two API calls, and the retrieved data is integrated into a single data summary. The user can also provide a schedule for executing the API script, e.g., at 6:00 pm every weekday, or when new data is added to a data store. An ETL orchestration system can manage API scripts received from users and automatically execute the API scripts on their specified schedules. At the scheduled time for an API script, the ETL orchestration system may forward the API script to an execution service, which translates API calls in the API script into data queries specific to the relevant data store, extracts the data using the data queries, and integrates the data according to the API script.

As an example, an API script received by the ETL orchestration system includes a first API call to a data projection that selects all parties to transactions and a second API call to a data projection that selects parties and their residency information. The first API call defines a first data projection of a first data store, and the second API call defines a second data projection of a second data store. The API script may specify that the extracted parties to the transactions from the first data store are correlated to the extracted residency information, and a new data set linking the extracted parties with their residences is created. The ETL orchestration system may re-run the API script at specified intervals and store each resulting data set; the results for each execution are based on current data in the two data stores.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 depicts a system environment for performing an ETL process, in accordance with an embodiment.

FIG. 2 depicts an example block diagram of an ETL orchestration System, in accordance with an embodiment.

FIG. 3 depicts an environment that includes data analysis system for extracting and integrating data from two external data sources, in accordance with an embodiment.

FIG. 4 is a flow process for performing an ETL process, in accordance with an embodiment.

### DETAILED DESCRIPTION

The figures and the following description relate to example embodiments by way of illustration only. It should be noted that from the following discussion, alternative embodiments of the structures and methods disclosed herein will be readily recognized as viable alternatives that may be employed without departing from the principles of what is claimed.

The figures use like reference numerals to identify like elements. A letter after a reference numeral, such as “110a,” indicates that the text refers specifically to the element having that particular reference numeral. A reference numeral in the test without a following letter, such as “110,” refers to any or all of the elements in the figures bearing that reference numeral. For example, “110” in the test refers to reference numerals “110a” and/or “110b” in the figures.

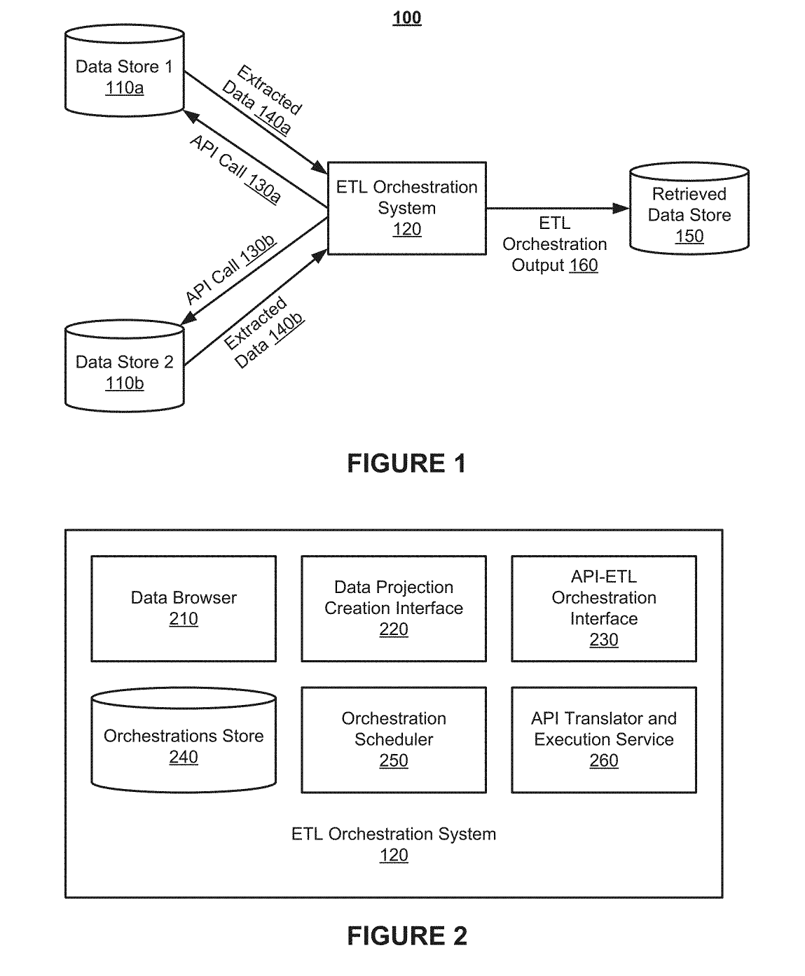

FIG. 1 depicts an exemplary system environment 100, in accordance with an embodiment. The system environment 100 includes two data stores 110a and 110b, an ETL orchestration system 120, and a retrieved data store 150. The ETL orchestration system 120 can perform an extract, transform, load (ETL) process on the data stored in the data stores 110a and 110b by extracting data from the data stores 110a and 110b, transforming the extracted data by performing one or more functions on the extracted data (e.g., reformatting, restructuring, combining, aggregating, filtering, summarizing, or merging the extracted data), and loading the transformed data into the retrieved data store 150.

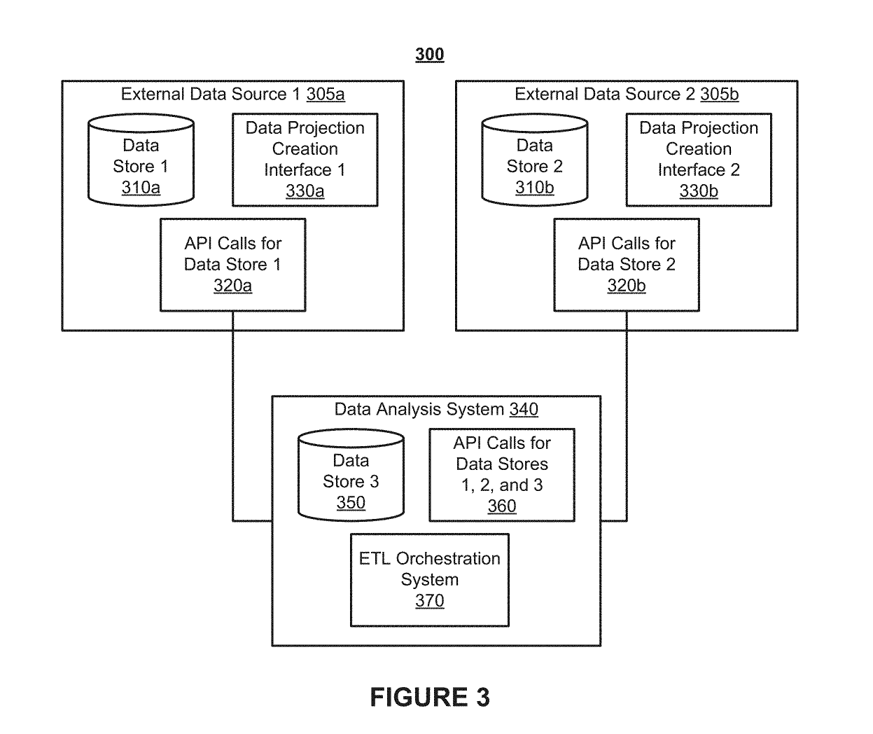

The ETL orchestration system 120 extracts data in the data stores 110a and 110b using API calls, such as API calls 130a or 130b, respectively. Each API call 130 defines a data projection of a particular data store 110. As used herein, a data projection describes a set or subset of data that can be retrieved from a particular data store 110. When executed, a data projection queries a data store 110 to generate a particular set of records representing the data specified by the data projection that is stored in the data store 110 at the time of execution. In some embodiments, the data projection further performs some transformation or enrichment of the extracted data. During execution, the API call is translated into one or more data store-specific data queries (e.g., SQL queries if the data store 110 is an SQL database). As described further below with respect to FIGS. 2 and 3, defining the available API calls for a particular data store 110 and translating the API calls into data store-specific queries can be performed at the data store 110 or at the ETL orchestration system 120 (in which case, the data-store specific queries, rather than the API calls 130 themselves, may be transmitted to the data stores 110).

The extracted data, e.g., extracted data 140a or 140b, returned from a data store 110 in response to an API call 130 represents a constituent building block for an ETL orchestration. Instructions that define steps for executing an ETL process are referred to as an “ETL orchestration.” Building upon the API calls 130, the ETL orchestration system 120 allows users to write ETL orchestrations as API scripts, which process or “chain” multiple API calls together. As discussed below, an API script for an ETL orchestration includes the particular API calls for extracting the desired data projections and describes how to process the extracted data, for example by filtering, joining, or otherwise processing the data retrieved from each data store. In some embodiments, ETL orchestrations, once defined, can be automatically executed by the ETL orchestration system 120.

For example, an API script can specify an ETL orchestration that involves extracting data from the data stores 110a and 110b using the API calls 130a and 130b. The API script further specifies how the data extracted using the API calls 130a and 130b is transformed, and that the resulting transformed data is loaded into the retrieved data store 150. The ETL orchestration system 120 can store received API scripts and perform ETL orchestration processes automatically according to schedules defined by users.

The system environment 100 may include any number of users with access to the ETL orchestration system 120. In some embodiments, users have different privileges or access levels. For example, some users may be administrators who can monitor and govern the ETL processes and tools described herein. Other, non-administrator users may be able to view available data, create ETL orchestrations, and view the resulting data sets.

The system environment 100 may include any number of data stores 110, each of which can be accessed by the ETL orchestration system 120 via API calls 130. In some embodiments, the API calls 130 are defined by the ETL orchestration system 120 as instructed by a user or administrator. In other embodiments, such as when the data stores 110 and the ETL orchestration system 120 are associated with different entities, the API calls 130 are defined by a computer system or entity associated with the data stores 110. The data stores 110 may each be accessible by the ETL orchestration system 120 over a network, e.g., a local area network (LAN) connecting devices in a closed network, or a wide area network (WAN) connecting devices across an open network. If the ETL orchestration system 120 accesses a data store 110a or 110b over an open network, such as the Internet, the data store 110 may restrict access to authorized systems or users.

Each data store 110 may include one or more computers, memory devices, servers, communications devices, and/or other computing equipment for storing and providing data. The data stored within each data store 110 may have any structure or format. For example, each data store 110 may store, for example, one or more relational databases, semi-structured data (e.g., data structured as CSV, logs, WL, or JSON), unstructured data (e.g., emails, documents, or PDFs), or binary data (e.g., images, audio, or video). In some embodiments, each of the data stores 110 or a set of data stores is a collection of differently-structured data forming a data lake. In some embodiments, different data stores 110 are constructed as different types of databases, such as navigational databases, graph databases, relational databases, network databases, or object databases. Further, different database tools, such as SQL, HADOOP, NoSQL, ORACLE, or SAP, may be used to access the different data stores 110.

When different data systems and data types are used by different data stores 110, this typically requires users to have a high degree of familiarity with the different data systems used in order to write ETL orchestrations involving the different data stores 110, and requires administrators of a data lake to support a diverse set of ETL tools for accessing different types of data. By defining API calls and using API scripts to manipulate data, users are no longer required to have deep knowledge of data systems or structure. Instead, once the ETL orchestration system 120 has been set up and the API calls 130 have been defined, an app-developer skill set is sufficient for users to extract data from the data stores 110 and write ETL orchestrations.

The ETL orchestration system 120 includes one or more computing devices configured to interface with the users and the data stores 110, store data, and execute ETL orchestrations, among other operations described herein. The ETL orchestration system 120 includes various components that assist users in writing ETL orchestrations and interacting with the data stores 110, and improve management of the ETL orchestration service. For example, the ETL orchestration system 120 allows users to browse the data available in the complex data lake, e.g., to view information about the data stores 110 and the data included in the data stores 110. The ETL orchestration system 120 allows users, after identifying data of interest, to define one or more API calls that can be used to extract the identified data. The ETL orchestration system 120 further allows users to write ETL orchestrations as API scripts that use the defined API calls to extract and transform data from the data stores 110. The ETL orchestration system 120 stores the API scripts and schedules for executing the scripts, and automatically executes the API scripts according to the schedule. A block diagram of an exemplary ETL orchestration system 120 is shown in FIG. 2.

By using API scripts to manage the ETL orchestration process, the ETL orchestration system 120 provides an ETL service that is easy for the users to use and more simple for an administrator to monitor and manage. Further, the ETL service provided by the ETL orchestration system 120 is governed, highly consistent, secure, and auditable due to the structure imposed by the API calls and API scripts, and the audit trail generated by the ingested data sets and calls used to generate the data sets. In addition, the API scripts and sub-components of the API scripts (including API calls and portions of the API scripts used for ETL orchestration) stored by the ETL orchestration system 120 can be quickly accessed and easily understood by other users, and prior transformations of data, or recipes used for transforming data, can be stored and accessed by other users. This can simplify the ETL process for users, who can build off of their own prior work or the work of other users.

The retrieved data store 150 stores and indexes the ETL orchestration output 160 from the ETL orchestration system 120, i.e., the integrated extracted data output according to the ETL orchestration. The retrieved data store 150 stores data output by prior ETL orchestration processes, which allows users to view current and past versions of the data resulting from ETL orchestrations. For example, as additional data is added to the data stores 110, and/or as data is removed from the data stores 110 (e.g., after becoming stale), the output 160 of the ETL orchestration will change. In addition, the retrieved data store 150 may store and index data products generated during execution of an ETL orchestration, such as the data extracted from data stores 110 according to API calls included in ETL orchestrations, and intermediate data produced during the transformation of data in an ETL orchestration. Each set of extracted data or intermediate data set may be stored along with an API call or API script used to generate the data. The retrieved data store 150 may include multiple physical data stores.

FIG. 2 depicts an example block diagram of the ETL orchestration system 120, in accordance with an embodiment. The ETL orchestration system 120 includes a data browser 210, a data projection creation interface 220, an API-ETL orchestration interface 230, an orchestrations store 240, an orchestration scheduler 250, and an API translator and execution service 260.

The data browser 210 provides a summary of data available for access and orchestration, e.g., in the data stores 110. The data browser 210 provides a list of all available data sets and information about each data set. For example, the information provided for each data set may include the data's source, how the data was generated, when the data was produced, the frequency at which the data is updated, the schema of the data, and sample data records. The data browser 210 may group the data by data store 110, data type, subject matter, size, or any other factors or combination of factors. In some embodiments, the summary provided by the data browser 210 includes any API calls that have been defined and can be used to access the data sets. For example, after an API call for a data projection on a particular data store 110 is defined (e.g., using the data projection creation interface 220, as described below), the API call and the data associated with it can be viewed in the data browser 210.

The data projection creation interface 220 provides an interface through which users can specify a data projection for extracting a data set from a data store 110. As discussed above, data projections can be invoked using API calls, such as API calls 130a and 130b. The output of the data projection creation interface 220 is one or more data projections defined as API calls that, when executed, each query a data store to extract the specified data and generate a data set that represents a constituent building block for an ETL orchestration. The available API calls for a particular data store 110 can be stored on the ETL orchestration system 120 and/or the data store 110, and can be viewed through the data browser 210.

For example, if a data store 110 includes a set records about customers, including customer IDs, customers' transactions, customers' complaints, and revenue from customers, a user could use the data projection creation interface 220 to create a data projection API set for this data store 110. For example, the data projection creation interface 220 may define three data projections as API calls, each of which performs a different operation on a different subset of the set of records in the data store:

API Call #1: Select all transactions, group by customer ID

API Call #2: Select all customer complaints, group by customer ID

API Call #3: Select revenue from all customers, group by customer ID.

The API-ETL orchestration interface 230 is an interface with which a user can define orchestrations using the data projections, defined as API calls, which were created using the data projection creation interface 220. The orchestrations are written as API scripts, and can integrate and interpret the data extracted by executing two or more data projections. For example, the API script can specify that the data extracted using two data projections are combined, aggregated, or merged, or that one or more extracted data projections are summarized or filtered.

Using the example API calls provided above, an exemplary API script for an ETL orchestration is as follows:

JOIN response(count((API Call #1)) with response (count(API Call #2))

UNION

Response (sum(API Call #3))

The above API script joins the count of the transactions provided by API call #1 with the count of the complaints provided by API call #2, and forms a data set as a union with the total sum of revenue, provided by API call #3. The API-ETL orchestration interface 230 also allows a user to provide a schedule for executing the orchestration, e.g., a set number of times per day, or at a particular time each day or week. The schedule may indicate a time or window of time to execute the orchestration, and a frequency for executing the orchestration. As another example, the schedule may indicate that the orchestration is executed when new data arrives in a particular data store 110. The API-ETL orchestration interface 230 may also allow a user to provide instructions for storing the result of the orchestration, e.g., to store the results at a particular storage location.

The orchestrations store 240 stores the orchestrations and schedules received by the API-ETL orchestration interface 230. The orchestrations store 240 stores all versions of each orchestration (e.g., the executable API script for retrieving and processing data); new versions of an ETL orchestration are created every time a user edits, modifies, changes or replaces an ETL orchestration. The orchestrations store 240 enables users to inspect the current and all past versions of their orchestrations. In some embodiments, the API scripts stored in the orchestrations store 240 by one user can be viewed by other users (e.g., all other users, or a subset of other users permitted access). For example, after the API-ETL orchestration interface 230 receives an API script from a first user and stores the API script in the orchestrations store 240, a second user with access to the orchestrations store 240 can view the first user's API script. The second user may modify the API script to create a new API script of use to the second user, or the second user may execute a portion of the API script. For example, if the first user wrote the API script in the above example, and the second user is interested only in the data resulting from the first line (JOIN response(count((API Call #1)) with response (count(API Call #2))), the second user can request that only this line is executed, or create a new API script (e.g., an orchestration) that consists only of this line.

In some embodiments, intermediate results of an API script are each associated with a new API call or an API address, providing easier access to such intermediate results. As an example, two additional API calls can be defined based on the intermediate results of the API script:

API Call #4: JOIN response(count((API Call #1)) with response (count(API Call #2))

API Call #5: response (sum(API Call #3))

The API-ETL orchestration interface 230 can store the above API calls in the orchestrations store 240, and the data resulting from the API calls along with the API calls themselves can be stored in the retrieved data store 150. In other embodiments, the above scripts are stored at addresses in the orchestrations store 240.

The orchestration scheduler 250 inspects the orchestrations store 240 and determines a set of orchestrations to execute at a given point in time or window of time. If each orchestration's schedule provides a window of time for execution (e.g., between 1:00 and 1:15, or between 1:00 and 1:01), the orchestration scheduler 250 ensures that orchestrations are scheduled for execution within the window of their specified execution time. The orchestration schedule 250 may perform load balancing by spreading the orchestrations out over time while keeping each orchestration within its window, so that at no time too many orchestrations are executed. The orchestration scheduler 250 also ensures that the output of each orchestration is appropriately stored and indexed to enable easy inspection by the user.

The API translator and execution service 260 executes the orchestrations at the times signaled by the orchestration scheduler 250. The API translator and execution service 260 translates each of the API calls into data store-specific data queries and executes the data queries as defined by the API script. In particular, the API translator and execution service 260 translates each API call for a data projection included in an API script into a data query that will extract the relevant data from the data store associated with the projection, executes the translated data queries to extract the data, and integrates the extracted data according to the ETL orchestration (e.g., by combining, filtering, or merging the extracted data).

In some embodiments, the API translation and execution of the data queries are performed at the data store 110 or a computer system affiliated with the data store 110, rather than by the ETL orchestration system 120. In such embodiments, the API translator and execution service 260 may be replaced by an execution service, which transmits the API calls to the data store 110, receives data extracted from the data stores 110 according to the API calls, and integrates the extracted data according to the ETL orchestration. In other embodiments, the API translation for some data stores (e.g., external data stores) are performed at the external data source, while the API translation for other data stores (e.g., internal data stores) are performed by the API translator and execution service 260. An example of this type of system, with internal and external data stores, is shown in FIG. 3.

In some embodiments, the API translator and execution service 260 may be executing a portion of an ETL orchestration while the retrieved data store 150 is storing another, already executed portion of data output by the same ETL orchestration. In addition, the API translator and execution service 260 may perform multiple aspects of the ETL orchestration in parallel; for example, the API translator and execution service 260 may translate one portion of an ETL orchestration, extract data for another portion of the ETL orchestration, and transform data for a third portion of the ETL orchestration. In other words, the API translator and execution service 260 and the retrieved data store 270 may perform parallel processes to extract, transform, and load the data in an efficient manner.

FIG. 3 depicts an environment 300 that includes a data analysis system 340 for extracting and integrating data from two external data sources 305a and 305b, in accordance with an embodiment. The data analysis system 340 has access to both internal data (data source 3 350) and external data (data stores 310a and 310b), and the data analysis system 340 can perform an ETL process on data from one or more external sources, the internal data source, or a combination of internal and external data sources. Each external data store 310 is prepared for extraction using API calls by an administrator of the external data source 305. These API calls are provided to the data analysis system 340 so that users of the data analysis system 340 can easily extract data from the external data stores 310.

As described above with respect to FIG. 1, when the data stores and the ETL orchestration system are associated with different entities, the API calls may be defined by the entity associated with the data stores. As shown in FIG. 3, each external data source 305 includes its own data store 310, set of API calls 320, and data projection creation interface 330. The data projection creation interface 330, similar to the data projection creation interface 220 described with respect to FIG. 2, allows a user to specify a data projection for extracting data from the data store 310; the data projections are defined by the data projection creation interface 330 as API calls 320. However, unlike the data projection creation interface 220 of FIG. 2, the data projection creation interface 330 is separate from the ETL orchestration system 370, and the data projection creation interface 330 may be managed by a user or administrator at the external data source 305. The API calls 320 and information for translating the API calls into data store-specific queries are stored locally at the external data source 305.

The data analysis system 340 also has a data store 350, and stores API calls for data stores 1 and 2 (received from the external data sources 305) API calls for data store 3. The API calls for data stores 1, 2, and 3 360 allow the data analysis system 340 to extract data from the data store 1 310a, data store 2 310b, and data store 3 350. The API calls for data store 3 350 within the data analysis system 340 are defined by a data projection creation interface included in the ETL orchestration system 370, which is similar to the ETL orchestration system 120 described with respect to FIGS. 1 and 2. The data browser in the ETL orchestration system 370 includes information about data store 1 310a, data store 2 310b, and data store 3 350. Users of the data analysis system 340 can write ETL orchestrations involving the first and second data stores 310a and 310b and the third data store 350 by writing API scripts that include API calls from the stored API calls for data stores 1, 2, and 3 360.

During execution, the API translator and execution service of the ETL orchestration system 370 translates the API calls for data store 3 350 into data store-specific data queries and execute the data queries. In some embodiments, the API translator and execution service transmits the API calls for data store 1 310a and data store 2 310b to the external data sources 305a and 305b without translation, and the external data sources 305a and 305b translate the API calls into data store-specific data queries, execute the data queries, and return the extracted data to the ETL orchestration system 370. In other embodiments, if the API translator and execution service has enough information about an external data store 310 and access to the external data store 310, the API translator and execution service may translate API calls to the external data store 310 into data-store specific data queries and directly execute the data queries on the external data store 310.

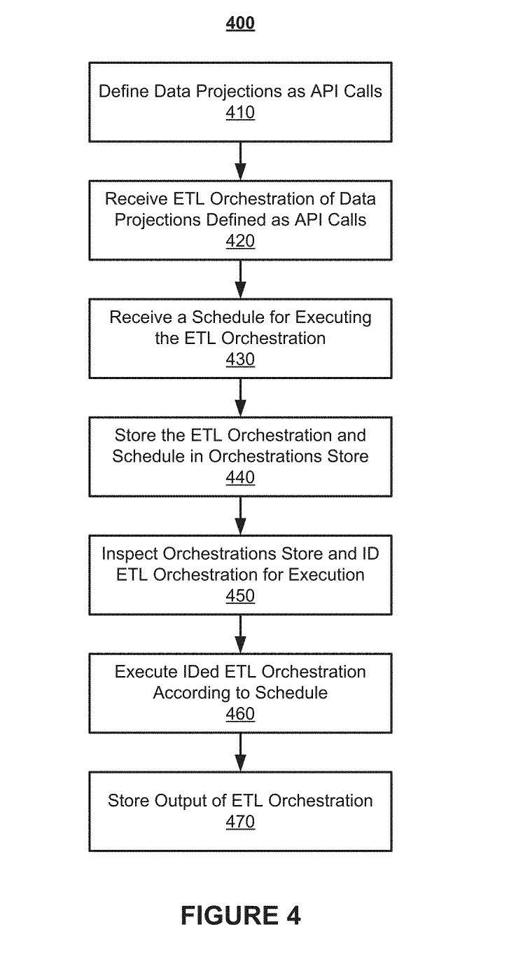

FIG. 4 is a flow process for performing an ETL process 400, in accordance with an embodiment. A data projection creation interface, such as data projection creation interface 220 or 330, defines 410 data projections as API calls. The data projections may be specified by a user based on data available in a data store 110 or 310.

An ETL orchestration interface, such as API-ETL orchestration interface 230, receives 420 an ETL orchestration of data projections that are defined as API calls. The ETL orchestration is specified by an API script. The orchestration may involve extracting data from the data projections and integrating the extracted data. The ETL orchestration interface also receives 430 a schedule for orchestrating the ETL orchestration. An orchestrations store, such as orchestrations store 240, stores 440 the received ETL orchestration and the received schedule.

An orchestration scheduler, such as orchestration scheduler 250, inspects 450 the orchestrations store and identifies one or more ETL orchestration for execution. The ETL orchestrations are identified for execution based on the execution times or time windows provided by their associated schedules.

An execution service, such as the API translator and execution service 260, executes 460 the identified ETL orchestration according to the schedule. For example, the execution service may translate the API call for each data projection in the ETL orchestration into a data query for extracting data from the data store associated with the data projection, execute the translated data queries to extract the data, and integrate the extracted data according to the ETL orchestration. After execution is complete, a retrieved data store, such as retrieved data store 150, stores the output of the ETL execution.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for performing a data extract, transform, load (ETL) process comprising:
receiving, at an ETL orchestration interface, an API script specifying an ETL orchestration to extract data using a plurality of data projections and integrate the extracted data, each data projection of the plurality of data projections defined as an API call and associated with a data store of a plurality of data stores;
receiving, at the ETL orchestration interface, a schedule for executing the ETL orchestration;
storing the API script specifying the ETL orchestration and the schedule for executing the ETL orchestration in an orchestrations store; and
executing, by an execution service, the stored API script specifying the ETL orchestration at a particular point in time determined based on the schedule for executing the ETL orchestration by:
translating, for each data projection of the plurality of data projections, the API call for the data projection into a data query for extracting data from the data store associated with the data projection;
executing the translated data queries to extract the data; and
integrating the extracted data according to the ETL orchestration.

2. The method of claim 1, wherein a first data projection and a second data projection of the plurality of data projections are associated with a data store of the plurality of data stores, the data store having a set of records, and the first data projection and the second data projection define different subsets of the records in the data store.

3. The method of claim 2, further comprising:
defining, using a data projection creation interface, the first data projection as a first API call that performs a first operation on the set of records in the data store; and
defining, using the data projection creation interface, the second data projection as a second API call that performs a second operation on the set of records in the data store.

4. The method of claim 1, wherein a first data store and a second data store of the plurality of data stores have different database formats.

5. The method of claim 1, wherein the API script specifying the ETL orchestration is received from a first user, the method further comprising:
storing, in the orchestrations store, a second API script specifying a second ETL orchestration; and
accessing, by the first user, the second API script specifying the second ETL orchestration.

6. The method of claim 1, further comprising providing, in a data browser, a summary of data available in the plurality of data stores, the summary comprising at least the plurality of API calls defining the plurality of data projections.

7. The method of claim 1, wherein integrating the extracted data involves at least one of:
combining a first data projection and a second data projection;
summarizing a data projection;
aggregating a first data projection and a second data projection;
filtering a first data projection; and
merging a first data projection and a second data projection.

8. The method of claim 1, further comprising storing and indexing the integrated extracted data output according to the ETL orchestration in a retrieved data store.

9. The method of claim 8, wherein the retrieved data store stores past versions of the ETL orchestration and allows a user to view current and past versions of the ETL orchestration.

10. The method of claim 1, further comprising storing, in the retrieved data store, the extracted data for each of the plurality of data projections and the API call defining the data projection associated with the extracted data.

11. A non-transitory computer readable storage comprising instructions that, when executed by a processor, cause the processor to:
receive, at an Extract, Transform, Load (ETL) orchestration interface, an API script specifying an ETL orchestration to extract data using a plurality of data projections and integrate the extracted data, each data projection of the plurality of data projections defined as an API call and associated with a data store of a plurality of data stores;
receive, at the ETL orchestration interface, a schedule for executing the ETL orchestration;
storing the API script specifying the ETL orchestration and the schedule for executing the ETL orchestration in an orchestrations store; and
execute, by an execution service, the stored API script specifying the ETL orchestration at a particular point in time determined based on the schedule for executing the ETL orchestration by:
translating, for each data projection of the plurality of data projections, the API call for the data projection into a data query for extracting data from the data store associated with the data projection;
executing the translated data queries to extract the data; and
integrating the extracted data according to the ETL orchestration.

12. The non-transitory computer readable storage of claim 11, wherein a first data projection and a second data projection of the plurality of data projections are associated with a data store of the plurality of data stores, the data store having a set of records, and the first data projection and the second data projection define different subsets of the records in the data store.

13. The non-transitory computer readable of claim 12, the instructions further comprising instructions that, when executed by the processor, cause the processor to:
generate, through a data projection creation interface, the definition of the first data projection as a first API call that performs a first operation on the set of records in the data store; and
generate, through the data projection creation interface, the definition of the second data projection as a second API call that performs a second operation on the set of records in the data store.

14. The non-transitory computer readable storage of claim 11, wherein a first data store and a second data store of the plurality of data stores have different database formats.

15. The non-transitory computer readable storage of claim 11, wherein the API script specifying the ETL orchestration is received from a first user, and the instructions further comprises instructions that, when executed by the processor, cause the processor to:
store, in the orchestrations store, a second API script specifying a second ETL orchestration; and
provide access, to the first user, to the second API script specifying the second ETL orchestration.

16. The non-transitory computer readable storage of claim 11, the instructions further comprising instructions that, when executed by the processor, cause the processor to provide, in a data browser, a summary of data available in the plurality of data stores, the summary comprising at least the plurality of API calls defining the plurality of data projections.

17. The non-transitory computer readable storage of claim 11, wherein the instructions that cause the processor to integrate the extracted data further cause the processor to:
combine a first data projection and a second data projection;
summarize a data projection;
aggregate a first data projection and a second data projection;
filter a first data projection; and
merge a first data projection and a second data projection.

18. The non-transitory computer readable storage of claim 11, wherein the instructions further comprises instructions that, when executed by the processor, cause the processor to store and index the integrated extracted data output according to the ETL orchestration in a retrieved data store.

19. The non-transitory computer readable storage of claim 18, wherein the retrieved data store stores past versions of the ETL orchestration and allows a user to view current and past versions of the ETL orchestration.

20. The non-transitory storage medium of claim 18, wherein the instructions further comprises instructions that, when executed by the processor, cause the processor to:
store, in the retrieved data store, the extracted data for each of the plurality of data projections and the API call defining the data projection associated with the extracted data.
